(19) United States
(12) Patent Application Publication
(10) Pub. No.: US 2007/0125320 A1
(43) Pub. Date: Jun. 7, 2007

(54) Oil-cooled internal combustion engine with rotary piston wall

(76) Inventors: Jerry L. Smith, Hesperia, CA (US); Cristine Lomeli, Camp Pendleton, CA (US)

Correspondence Address: Donald W. Meeker;Patent Agent, 924 East Ocean Front #E, Newport Beach, CA, 92661, US

(21) Appl. No.: 11/294,781

(22) Filed: Dec. 5, 2005

(51) Int. Cl. F01C 9/00; F01C 1/07; F02B 53/00

(52) U.S. Cl. 123/18 R

(57) ABSTRACT

A 4-cycle, 4-cylinder internal combustion engine which comprises a hollow cylindrical engine casing with only three moving parts, a single rotary piston wall and two rotatable valve cylinders. A hollow cylindrical motor casing is divided in half vertically by an internal dividing wall. A single oil-cooled rotary piston wall is pivotally attached to the center of the internal dividing wall to create four variable size cylinders as the rotary piston wall pivots back and forth with the firing of the four spark plugs each firing into one of the four cylinders.

### CROSS-REFERENCE TO RELATED APPLICATIONS

Not Applicable.

### STATEMENT REGARDING FEDERALLY SPONSORED RESEARCH OR DEVELOPMENT

Not Applicable.

### THE NAMES OF THE PARTIES TO A JOINT RESEARCH OR DEVELOPMENT

Not Applicable.

### BACKGROUND OF THE INVENTION

1. Field of the Invention

The present invention relates to internal combustion engines and specifically to a 4-cycle, 4-cylinder internal combustion engine with a single oil-cooled rotary piston wall that when fired upon by a cylinder on a first side, moves to compress the exhaust gasses on the same side and opens the intake cylinder on the opposite side, the engine having only three moving parts.

2. Description of Related Art Including Information Disclosed under 37 CFR 1.97 and 1.98

In an effort to eliminate many of the engineering problems associated with reciprocating, piston-type internal combustion engines, a considerable amount of research and design work has been directed toward development of a rotary type of engine. This effort has led to the development of different types of rotary engines, such as rotary engines having a three-lobed rotor for movement around a three-lobed chamber, rotary engines having special rotating abutments, and rotary engines with special sliding abutments. None of the prior art engines has provided a fuel efficient engine with only three moving parts.

Prior art U.S. Pat. No. 4,664,078, issued May 12, 1987 to Bender, is for a substantially continuously rotating internal combustion engine. The engine has a rotatable casing with a hollow cylindrical interior cavity which includes one or more partition members. A shaft and vane assembly is also held within the cavity, and the shaft and vane assembly has the same number of vanes as the casing has partitions. The engine is a four-cycle internal combustion engine, and both the casing and the vanes rotate, and each provides power to the output gear.

Prior art U.S. Pat. No. 6,113,370, issued Sep. 5, 2000 to Volftsun, provides a rotary-vane machine having a stationary shell including a casing member, a camming ring having an internal, noncircular camming surface, and a flange member; a rotor including at least two first vanes fixedly attached to, or integral with, the rotor, a first cover plate fixedly attachable to the rotor; a second cover plate fixedly attachable to the rotor and integral with a first shaft supported on its free end by bearing mounted in the casing, and being provided with at least four ports for access or egress of a working medium; a second shaft supported by a first bearing accommodated in the first cover plate and by a second bearing accommodated in the second cover plate; at least two second vanes fixedly attached to the second shaft and oscillatably accommodated within the rotor, and defining, together with the rotor, the first vanes and the first and second cover plates, a plurality of chambers; a cross piece integral with the second shaft and having at least one lateral projection mounting at least one block pivotable about a pivot; at least one third shaft eccentrically projecting from the second cover plate, the end portion of which shaft is connected to a coupling member for connection to a source of rotational power; at least one cam follower pivotably mounted between the second cover plate and the coupling member on the at least one third shaft and comprising two rollers riding along the internal surface of the cam follower, further comprising two laterally extending arms, the ends of which are adapted to act on the cross piece, and an inlet and outlet manifold mounted in the casing and rotationally stationary relative thereto and in contact with the second cover plate, the manifold having at least one pair of inlet and outlet ducts and ports disposed so as to provide communication between the ports in the second cover plate and an inlet and outlet port respectively in the casing.

Prior art U.S. Pat. No. 1,142,576, issued Jun. 8, 1915 to Inshaw, shows a 4-cycle rotary internal combustion engine having a first set of vanes secured to the engine casing and a second set of vanes mounted on and movable with a shaft which runs through the interior of the casing.

Prior art U.S. Pat. No. 1,981,615, issued Nov. 20, 1934 to Enderlin, claims a rotary internal combustion motor which is subdivided into two chambers by pistons secured to the interior walls of the combustion chamber. Two cylinder heads which cooperate with the pistons are secured to and movable with a shaft disposed within the chamber.

Prior art U.S. Pat. No. 1,318,017, issued Oct. 7, 1919 to Shank, is for a combustion engine of the rotary type using liquid gasoline or other hydrocarbon oils as fuel combined with compressed air and steam for the motive agent. A cylinder has rotors therein each having rotor heads adapted to become abutments and means to admit air into the cylinder to be compressed and by the advancing rotor and combined with the fuel to be ignited by a spark.

Prior art U.S. Pat. No. 1,739,104, issued Dec. 10, 1929 to Tropp, is about a rotary internal combustion engine having a housing with an inlet and exhaust openings and means for igniting a charge and a pair of coaxial rotors relatively movable on their axes in the housing. The rotors having metrically opposite impellers and a sleeve extending from each rotor out of opposite sides of the housing, a shaft revolvably mounted in the sleeves, a rocker arm carried by each sleeve, a cam for each rocker arm carried by the housing and adapted to engage the corresponding rocker arm at intervals of 180 degrees, a second cam for each rocker arm carried by the shaft, the second cam adapted to engage the corresponding rocker arm at intervals of 120 degrees, with the cams and rocker arms coupling and uncoupling the rotors to the shaft and housing.

Prior art U.S. Pat. No. 6,305,345, issued Oct. 23, 2001 to Bakhtine, has an oscillatory scissor type rotary engine having two rotors wherein first and second rotor drive mechanisms are located on first and second opposite sides of the engine respectively, each rotor drive mechanisms including a carrier bowl that is rigidly fixed to an output shaft passing through the two hollow rotor drive shafts and mounted in bearings thus obviating the need for a separate drive mechanism support structure. By evenly spreading the load between all meshed gears through the provision of shock-absorbent members in the connecting rod heads, and of an increased number of symmetrically positioned planetary crank-and-pinion units on each side of the engine, and by evening out the impact loading through the use of drive components as flywheels, the resultant design is made simple, reliable, durable and dynamically balanced. The unique co-axial shaft arrangement ensuring precise rotor positioning enables elimination of conventional mechanical sealing and instead provides dynamic sealing of gases, to improve the durability of engine components. These dynamic gaps additionally accommodate heat-insulating coatings in the gaps between the housing and vanes and oh the vanes themselves, which in turn result in reduced heat loads on major engine components, enabling the elimination of substantial housing cooling requirements. This advantage can permit housing/component cooling solely by means of circulating oil lubricant in cooling conduits in the housing and vanes, without the need for additional water cooling equipment, thereby to save manufacturing costs.

Prior art U.S. Pat. No. 3,227,090, issued Jan. 4, 1966 to Bartolozzi, talks about an engine or pump having rotors defining chambers of variable volumes. An annular shaped chamber has an axial shaft with rotors on the form of rings with radial pistons. The rings are rotated in only one and same direction. The rings rotate around the same axis and are alternately moved in such a manner that while one ring is rotating, the other one is fixed.

Prior art U.S. Pat. No. 6,158,987, issued Dec. 12, 2000 to Raikamo, demonstrates a power unit for use as a pressure-fluid-operated motor and/or a pressure fluid pump, the power unit comprising a cylinder space, pistons movable in the cylinder space and channels for pressure fluid. The cylinder is annular and the pistons extend radially to the inner circumferential surface of the cylinder space and are arranged to rotate around the axis of the cylinder space. The power unit further comprises a transmission shaft and locking members for successively locking the pistons so that they cannot rotate with respect to the cylinder space. The pistons are alternately locked while pressure fluid is alternately supplied and discharged from chambers between the pistons so that the pistons are rotated in succession either to deliver power as a motor or pressurized fluid as a pump.

Prior art U.S. Pat. No. 3,935,841, issued Feb. 3, 1976 to Longeval, puts forth a rotary internal combustion engine which is entirely cylindrical. The engine includes a cylindrical stator having mounted for rotation therein two pairs of blades on concentric shafts. Means, preferably a universal joint is provided which operates through a gear case to control the relative speeds of the shafts and thus the angle between the blades to change the volume of the combustion chamber through the four operations of intake, compression, expansion (power) and exhaust.

Prior art U.S. Pat. No. 6,948,473, issued Sep. 27, 2005 to Udy, shows four-cycle rotary engines, with an even number of hinged-hub impeller vanes, utilize dependently rotating, joined, hinged-hub impellers, with interdigitated, alternating hub sections, on a shared, power output shaft, and electromagnetic fields, and timing of impeller release and capture, to provide real time compression ratio control, and to control the momentum of the rotating impellers, and mechanical clutches to transfer the rotation to the power shaft.

Prior art U.S. Pat. No. 6,386,838, issued May 14, 2002 to Hoyt, provides a reciprocating rotating engine having a combustion chamber and a pumping chamber provided with two sets of free pistons and pumps vanes each set having two pistons and two pump vanes. The two sets of pistons and pump vanes define four separate combustion chamber portions and pumping chamber portions and reciprocally rotate in concentric circular paths under the force of compression ignited internal combustion forces, pumping and pressurizing hydraulic fluid contained within the pumping chamber.

Prior art U.S. Pat. No. 190 859,959, issued Jul. 16, 1907 to Marsh, claims a rotary engine including a cylinder having an inlet and eduction ports and valves, a shaft extending through the cylinder, a propeller consisting of more than two blades, each being independently journaled from the shaft within the cylinder and a means for rotating the blades and simultaneously locking a plurality of the blades against a reverse movement.

Prior art U.S. Pat. No. 4,744,736, issued May 17, 1988 to Stauffer, illustrates an internal combustion engine of the rotary type in which a pair of axially spaced combustion chambers are provided and a common ratchet or control mechanism is positioned between the spaced combustion chambers. A pair of vanes are mounted in each combustion chamber with the vanes mounted on concentric shafts and free to rotate relative to each other. The ratchet mechanism positioned between the combustion chambers functions to resist counterclockwise movement of the vanes in one combustion chamber while allowing free clockwise movement thereof and to resist clockwise movement of the vanes in the other combustion chamber while allowing free counterclockwise movement thereof. The reaction forces generated in the ratchet mechanism from the two combustion chambers thus tend to cancel each other out. The central ratchet mechanism includes a housing which absorbs the reaction forces from both combustion chambers and which is free to rotate in the event that the reaction forces generated in the two combustion chambers become unbalanced.

What is needed is a highly efficient engine structured with only three moving parts and operating in a highly efficient manner for improved fuel efficiency, low maintenance, and long life.

### BRIEF SUMMARY OF THE INVENTION

An object of the present invention is to provide a highly efficient engine structured with only three moving parts having a cylindrical oil cooled casing divided into two internal chambers by an internal stationary central dividing wall and a rotary piston wall pivotally attached to a post in the center of the dividing wall with half of the rotary piston wall in each of the two chambers extending to the cylindrical cylinder casing wall to create four chambers variable in size as the rotary piston wall rotates back and forth to create four pistons in one with the four chambers alternately performing the four strokes (intake, exhaust, compression, and firing) so that the rotary piston wall when fired upon by a firing stroke on a first side, moves to compress the exhaust gasses on the same side in a compression stroke and opens one chamber on the opposite side of the dividing wall in an intake stroke and closes the other chamber in an exhaust stroke as the pivotable wall rotates with a firing turning operating in a highly efficient manner for improved fuel efficiency, low maintenance, and long life.

A related object of the present invention is to provide an oil cooling system with oil pumped through the outer cylindrical casing wall, the dividing wall, the rotary piston wall and the rotary piston wall post for a highly efficient oil cooled engine.

Another object of the present invention is to provide an engine structured with only three movable parts and re-sleevable cylinders which may be completely overhauled in less than one hour, at a fraction of the cost of a typical 4-cycle engine.

An additional object of the present invention is to provide an engine having a valve assembly with tubular construction which allows two cylinders to function from the one unit, thereby providing low emissions and a high fuel economy.

A further object of the present invention is to provide an engine structure that by varying the diameter and length of the engine the application can be anything from a lawnmower, a chainsaw, a weed-eater, a blower, a high performance race engine, a tractor-trailer, and other transportation means in addition to automobiles and trucks.

A contributory object of the present invention is to provide a highly efficient engine whose horsepower to weight ratio is extremely high.

In brief, a highly efficient 4-cylinder, 4-cycle engine structured with only three moving parts. The engine has a cylindrical oil cooled casing divided into two internal chambers by an internal stationary central dividing wall and a rotary piston wall pivotally attached to a post in the center of the dividing wall with half of the rotary piston wall in each of the two chambers extending to the cylindrical cylinder casing wall to create four chambers variable in size as the rotary piston wall rotates back and forth to create four pistons in one with the four chambers alternately performing the four strokes (intake, exhaust, compression, and firing). When the rotary piston wall is fired upon by a firing stroke on a first side, it moves to compress the exhaust gasses on the same side in a compression stroke and opens one chamber on the opposite side of the dividing wall in an intake stroke and closes the other chamber in an exhaust stroke as the pivotable wall rotates with a firing turning. Combustion chamber sealing is accomplished with a rectangular stock. These are forced and held into place by the use of engine oil pressure.

The valve assembly is unique in that its tubular construction allows two cylinders to function from the one unit. The two valve assemblies with one on each side of the engine block cylinder comprise two of the moving parts in addition to the rotary piston wall which is the third moving part.

Incorporated along with air-cooling is a unique oil lubrication system, which aids in removing heat from the rotary piston wall. This is accomplished by passing engine oil through the piston, under pressure, and then through an external oil cooler. The engine operates in a highly efficient manner for improved fuel efficiency, low maintenance, and long life.

The cylinders are re-sleevable, allowing the engine to be completely overhauled in less than one hour, at a fraction of the cost of a typical 4-cycle engine.

The engine's horsepower to weight is extremely high. By varying the diameter and length of the engine, the application can be everything from a lawnmower, a weed-eater, a chainsaw, a blower, a high performance race engine, a tractor-trailer, and other transportation means in addition to automobiles and trucks. With a smaller diameter of the engine the RPM is higher and the torque lower, for applications such as racing engines. A larger diameter gives lower RPM and higher torque, for applications such as tractor-trailers.

The purpose of the device is to provide a 4-cylinder, 4-cycle engine with only three moving parts for working in a highly efficient manner for improved fuel efficiency and emissions, low maintenance, and long life.

An advantage of the present invention is that it is highly fuel efficient.

Another advantage of the present invention is that it requires low maintenance.

One more advantage of the present invention is that it is very reliable.

An additional advantage of the present invention is that it has low emissions.

A further advantage of the present invention is that is has an extremely high horsepower to weight ratio.

Yet another advantage of the present invention is that it is quick and less costly to repair.

### BRIEF DESCRIPTION OF THE SEVERAL VIEWS OF THE DRAWINGS

These and other details of my invention will be described in connection with the accompanying drawings, which are furnished only by way of illustration and not in limitation of the invention, and in which drawings:

FIG. 1 is a plan view in partial section of the interior of the hollow cylindrical engine casing of the present invention showing the three moving parts including the rotary piston wall and the two rotatable valve cylinders and showing spark plug 31A firing with cylinder 1 in a firing stroke, cylinder 2 in an exhaust stroke, cylinder 4 in an intake stroke, and cylinder 3 in a compression stroke and the rotary piston wall rotating clockwise;

FIG. 2A is a plan view of the hollow cylindrical engine casing of FIG. 1 showing cycle 1 with spark plug number 31C firing and cylinder 4 in a firing stroke, cylinder 3 in a compression stroke, cylinder 1 in an intake stroke, and cylinder 2 in an exhaust stroke, and the rotary piston wall rotating clockwise;

FIG. 2B is a plan view of the hollow cylindrical engine casing of FIG. 1 showing cycle 2 with spark plug 31D firing and cylinder 3 in a firing stroke, cylinder 4 in an exhaust stroke, cylinder 2 in an intake stroke, and cylinder 1 in a compression stroke and the rotary piston wall rotating counter clockwise;

FIG. 2C is a plan view of the hollow cylindrical engine casing of FIG. 1 showing cycle 3 with spark plug number 31A firing and cylinder 1 in a firing stroke, cylinder 2 in a compression stroke, cylinder 4 in an intake stroke, and cylinder 3 in an exhaust stroke and the rotary piston wall rotating clockwise;

FIG. 2D is a plan view of the hollow cylindrical engine casing of FIG. 1 showing cycle 4 with spark plug 31B firing and cylinder 2 in a firing stroke, cylinder 1 in an exhaust stroke, cylinder 3 in an intake stroke, and cylinder 4 in a compression stroke and the rotary piston wall rotating counter clockwise;

FIG. 3 is an exploded perspective view of the rotary piston wall engine block system showing the components aligned for assembly;

FIG. 4 is a partial cross-sectional view of the cylindrical engine casing wall showing a spark plug mounted therein and an end of the rotary piston wall where it meets the engine casing wall;

FIG. 4A shows an exploded view of the detail A of the end of the rotary piston wall of FIG. 4;

FIG. 5A shows a horizontal cross-sectional view of the rotary piston wall of FIG. 1 showing the internal oil circulation channels;

FIG. 5B shows a vertical cross-sectional view of the rotary piston wall of FIG. 1 showing the internal oil circulation channels;

FIG. 6 shows a vertical cross-sectional view taken through the vertical centerline of the cylindrical engine casing wall of FIG. 1 showing the engine end caps aligned for mounting;

FIG. 7 is a plan view in partial section of the interior of the hollow cylindrical engine casing of FIG. 1 showing a replaceable interior sleeve in the cylindrical engine casing;

FIG. 7B is an enlarged view of detail B of FIG. 7 showing the internal oil channels in the vertical central dividing wall and the rotary piston wall.

### DETAILED DESCRIPTION OF THE INVENTION

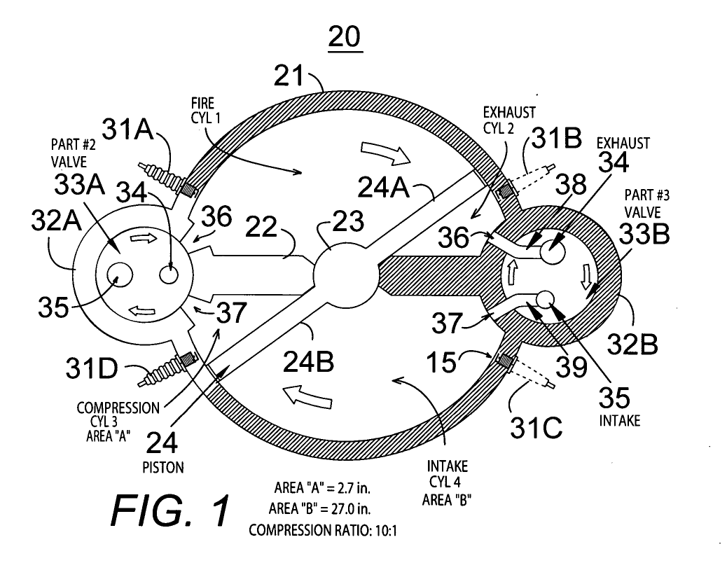

In FIGS. 1-7, a rotary piston wall engine block system 20 comprises a hollow cylindrical engine casing 21 with only three moving parts: a rotary piston wall 24 and two rotatable valve cylinders 33A and 33B.

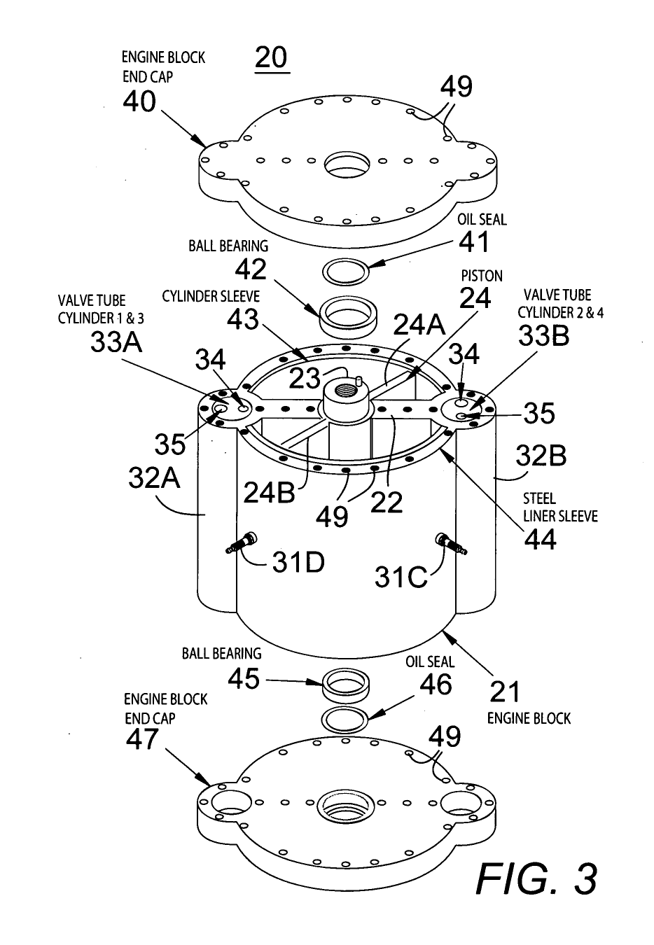

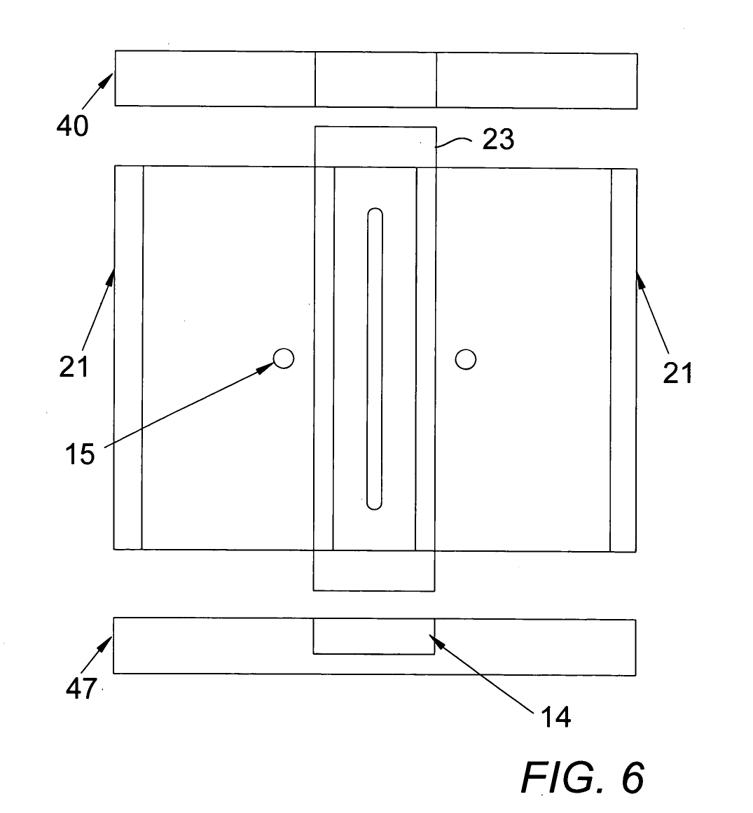

The vertical hollow cylindrical engine casing 21 comprises an outer shell and a hollow interior cylinder space divided vertically into two equal internal vertical chambers by an internal stationary vertical central dividing wall 22. The vertical engine casing 21 also comprises pair of engine block caps 40 and 47, shown in FIGS. 3 and 6, each enclosing one of a top and a bottom opening in the vertical hollow cylindrical engine casing 21.

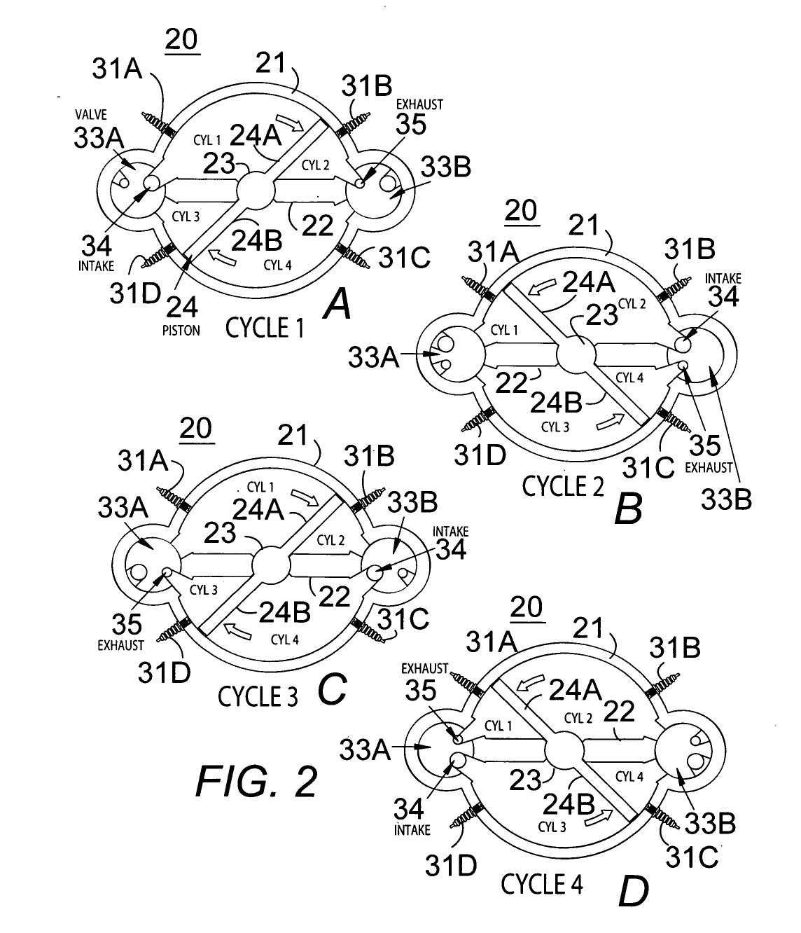

The engine block system 20 comprises a vertical rotary piston wall 24 pivotally attached to a vertical post 23 in the center of the dividing wall 22 with half 24A or 24B of the rotary piston wall 24 in one of each of the two vertical chambers extending to the interior of the cylindrical cylinder casing wall 21 to create four chambers (Cylinders 1-4) variable in size as the rotary piston wall 24 rotates back and forth. When the rotary piston wall 24 rotates back and forth it creates four pistons in one with the four chambers (Cylinders 1-4) performing four strokes including an intake stroke, an exhaust stroke, a compression stroke, and a firing stroke, as illustrated in FIGS. 2A-2D. The rotary piston wall 24 pivots upon receiving a force from a firing stroke on a first side of the rotary piston wall 24 and a first side of the dividing wall 22 to compress the exhaust gasses on a second side of the rotary piston wall 24 on the first side of the dividing wall 22 in a compression stroke and opens a first chamber on a second side of the dividing wall 22 in an intake stroke and closes a second chamber on the second side of the dividing wall 22 in an exhaust stroke as the pivotable wall rotates 24.

The engine block system 20 further comprises a pair of vertical valve tube cylinders 33A and 33B built into the engine casing 21 at each of two ends of the central dividing wall 22 running the height of the cylindrical engine casing 21. Each of the valve tube cylinders 33A and 33B comprises a vertical cylindrical valve shell 32A and 32B with a hollow vertical cylindrical interior space housing a rotatable valve cylinder 33A and 33B. Each of the rotatable valve cylinders 33A and 33B have a pair of vertical spaced openings 34 and 35 in the rotatable valve cylinder 33A and 33B comprising an intake opening 34 and an exhaust opening 35 vertically through the length of the rotatable valve cylinder 33A and 33B. Each of the pair of vertical spaced openings 34 and 35 each have a pair of communicating openings 38 or 39 each positioned on one side of each of the vertical spaced openings 34 or 35 in the rotatable valve cylinders 33A and 33B. Each of the communicating openings 38 or 39 communicate with one portion of one of the vertical chambers (Cylinder 1, 2, 3, or 4) only when one of the rotatable valve cylinders 33A or 33B is rotated to a position wherein one of the communicating openings 38 or 39 is aligned with one of the engine casing openings 36 or 37, so that fuel is admitted from the intake opening 34 into the portion of one of the vertical chambers (Cylinders 1-4) acting as an intake cylinder during an intake stroke of the rotary piston wall 24, and so that exhaust is drawn out through the exhaust opening 35 from the portion of the other of the vertical chambers (Cylinders 1-4) acting as an exhaust cylinder during an exhaust stroke of the rotary piston wall 24 and at the same time the other of the rotatable valve cylinders 33A or 33B is rotated to a third or a fourth position with the intake and exhaust cylinders not in communication with the two other portions of the vertical chambers (Cylinders 1-4) which are in a firing stroke and a compression stroke, the rotatable valve cylinders 33A and 33B rotated into the desired positions as each portion of the vertical chambers (Cylinders 1-4) alternates through the series of strokes, as depicted in FIGS. 2A-2D.

FIG. 2A shows cycle 1 with spark plug number 31C firing and cylinder 4 in a firing stroke, cylinder 3 in a compression stroke, cylinder 1 in an intake stroke, and cylinder 2 in an exhaust stroke and the rotary piston wall rotating clockwise.

FIG. 2B shows cycle 2 with spark plug 31D firing and cylinder 3 in a firing stroke, cylinder 4 in an exhaust stroke, cylinder 2 in an intake stroke, and cylinder 1 in a compression stroke and the rotary piston wall rotating counter clockwise.

FIG. 2C shows cycle 3 with spark plug number 31A firing and cylinder 1 in a firing stroke, cylinder 2 in a compression stroke, cylinder 4 in an intake stroke, and cylinder 3 in an exhaust stroke and the rotary piston wall rotating clockwise.

FIG. 2D shows cycle 4 with spark plug 31B firing and cylinder 2 in a firing stroke, cylinder 1 in an exhaust stroke, cylinder 3 in an intake stroke, and cylinder 4 in a compression stroke and the rotary piston wall rotating counter clockwise.

The engine block system 20 further comprises four spark plugs 31A, 31B, 31C and 31D each installed through a vertical midpoint spark plug opening 15 in the cylindrical engine casing 21, as shown in FIG. 6, adjacent to one of the valve tube cylinders 33A and 33B, so that each of the spark plugs 31A, 31B, 31C and 31D fires in a timed sequence to ignite fuel in a portion of one of the internal chambers (Cylinders 1-4) to create the firing stroke. When the rotation of the rotary piston wall 24 reaches a limit in the portion of an interior chamber in a compression stroke, the spark plug 31A, 31B, 31C or 31D in that portion of the interior chamber (Cylinder 1, 2, 3, or 4) ignites a compressed fuel/air mixture therein to create a firing stroke moving the rotary piston wall 24 in the opposite direction, so that each of the four spark plugs 31A, 31B, 31C and 31D fires in sequence as the two portions of each of the two vertical chambers cycle through the four cycles, as shown in FIGS. 2A-2D.

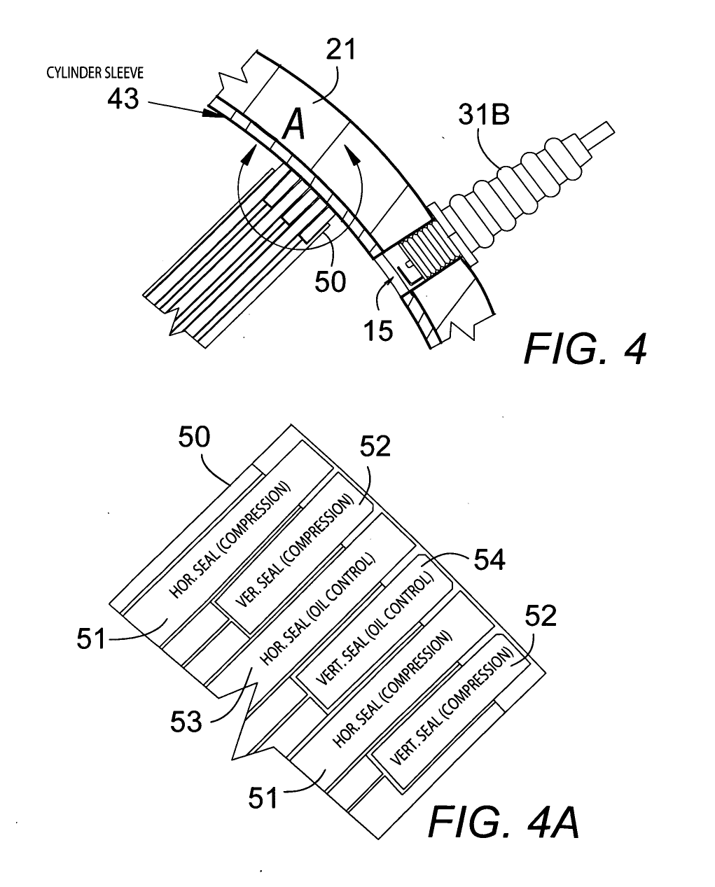

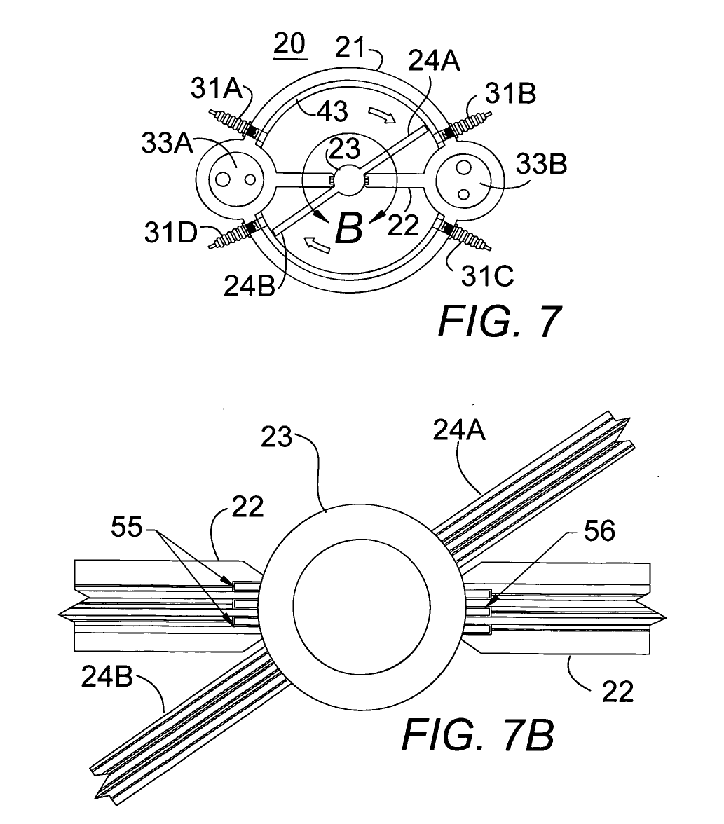

The engine system 20 includes rectangular stock 50, 55 and 56, shown in FIGS. 4A, 4B and 7B, for sealing a portion of the inner chamber (Cylinders 1-4) during combustion in a firing cycle, the rectangular stock 50, 55 and 56 is forced and held in place by the use of engine oil pressure.

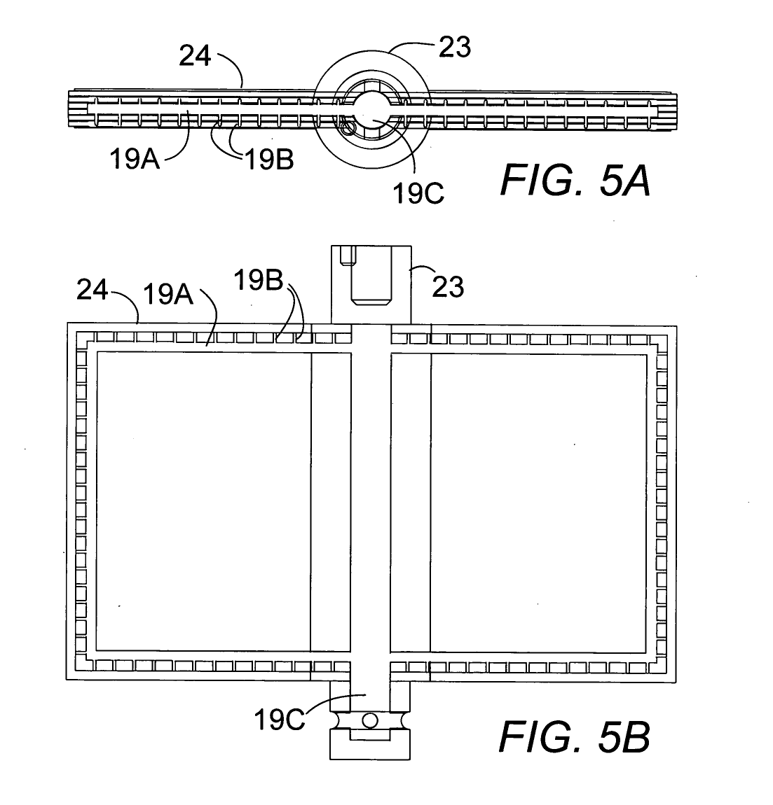

In FIGS. 5A and 5B, the engine block system 20 also includes series of spaced passageways 19A, 19B and 19C inside the outer cylindrical casing wall 21, the dividing wall 22, the rotary piston wall 24 and the rotary piston wall post 23 to receive oil pumped under pressure through the spaced passageways 19A, 19B and 19C and through an external oil cooler (not shown) to cool the engine block 20 and to lubricate the rotary piston wall 24.

The rotary piston wall 24 and the two rotatable valve cylinders 33A and 33B are the only moving parts in the engine block 20 so that the engine block system 20 operates in a highly efficient manner for fuel efficiency, low exhaust emissions, low maintenance, and long life. The engine block system 20 output in horsepower to weight ratio is extremely high.

The application of the engine block system 20 can vary based upon the diameter and the length of the engine casing 21. A small diameter engine casing 21 produces a high RPM and low torque for applications to vehicles for fast speed. A large diameter engine casing 21 produces a low RPM and high torque for applications to vehicles for hauling loads. Using various engine casing 21 diameters and lengths enables a wide variety of applications including use in automobiles, trucks, lawnmowers, chainsaws, weed-eaters, blowers, high performance race cars, tractor-trailers, boats, and aircraft.

The engine block 20 has few parts for ease of assembly and disassembly. The engine block system 20 has a sleeve lining 43 within the cylindrical engine casing 21, seen in FIGS. 1, 4 and 7, which is removable and replaceable for rapid repair.

In use, the engine block system 20 may have many applications. By varying the diameter and length of the engine casing 21, the application can be anything from a lawnmower, a chainsaw, a weed-eater, a blower, a high performance race engine, a tractor-trailer, and other transportation means in addition to automobiles and trucks. With a smaller diameter casing 21 of the engine 20 the RPM is higher and the torque lower, for applications such as racing engines. A larger diameter casing 21 gives lower RPM and higher torque, for applications such as tractor-trailer trucks.

To repair the engine, the engine block caps 40 and 47, shown in FIGS. 3 and 6, are easily removed from the top and bottom openings in the engine casing 21. The moving parts, a rotary piston wall 24 and two rotatable valve cylinders 33A and 33B can be easily removed and repaired or replaced if necessary. The cylinders of the engine 20 may be re-sleeved (sleeve 43 shown in FIGS. 1, 4 and 7). Once repairs are made the engine block caps 40 and 47 are put back in place and secured by screws threadingly engaged in screw apertures 49 in both the end block caps 40 and 47 and the ends of the casing 21 and dividing wall 22. These features allow the engine 20 to be completely overhauled in less than one hour, at a fraction of the cost of a typical 4-cycle engine.

It is understood that the preceding description is given merely by way of illustration and not in limitation of the invention and that various modifications may be made thereto without departing from the spirt of the invention as claimed.

What is claimed is:

1. A rotary piston wall engine block system comprising:
a vertical hollow cylindrical engine casing comprising an outer shell and a hollow interior cylinder space divided vertically into two equal internal vertical chambers by an internal stationary vertical central dividing wall, a pair of engine block caps each enclosing one of a top and a bottom opening in the vertical hollow cylindrical engine casing;
a vertical rotary piston wall pivotally attached to a vertical post in the center of the dividing wall with half of the rotary piston wall in each of the two vertical chambers extending to the cylindrical cylinder casing wall to create four chambers variable in size as the rotary piston wall rotates back and forth to create four pistons in one with the four chambers performing four strokes including an intake stroke, an exhaust stroke, a compression stroke, and a firing stroke, so that the rotary piston wall pivots upon receiving a force from a firing stroke on a first side of the rotary piston wall and a first side of the dividing wall to compress the exhaust gasses on a second side of the rotary piston wall on the first side of the dividing wall in a compression stroke and opens a first chamber on a second side of the dividing wall in an intake stroke and closes a second chamber on the second side of the dividing wall in an exhaust stroke as the pivotable wall rotates;
a pair of vertical valve tube cylinders built into the engine casing at each of two ends of the central dividing wall running the height of the cylindrical engine casing, each of the valve tube cylinders comprising a vertical cylindrical valve shell with a hollow vertical cylindrical interior space housing a rotatable valve cylinder having a pair of vertical spaced openings in the rotatable valve cylinder comprising an intake opening and an exhaust opening vertically through the length of the rotatable valve cylinder, each of the pair of vertical spaced openings each having a pair of communicating openings each positioned on one side of each of the vertical spaced openings in the rotatable valve cylinder and each of the communicating openings communicating with one portion of one of the vertical chambers only when one of the rotatable valve cylinders is rotated to a position wherein at least one of the communicating openings is aligned with one of the engine casing openings so that fuel is admitted from the intake opening into the portion of one of the vertical chambers acting as an intake cylinder during an intake stroke of the rotary piston wall and so that exhaust is drawn out through the exhaust opening from the portion of the other of the vertical chambers acting as an exhaust cylinder during an exhaust stroke of the rotary piston wall and at the same time the other of the rotatable valve cylinders is rotated to a third or a fourth position with the intake and exhaust cylinders not in communication with the two other portions of the vertical chambers which are in a firing stroke and a compression stroke, the rotatable valve cylinders rotated into the desired positions as each portion of the vertical chambers alternates through the series of strokes;
four spark plugs each installed through a vertical midpoint of the cylindrical engine casing adjacent to one of the valve tube cylinders so that each of the spark plugs fires in a timed sequence to ignite fuel in a portion of one of the internal chambers to create the firing stroke, so that as the rotation of the rotary piston wall reaches a limit in the portion of an interior chamber in a compression stroke, the spark plug in that portion of the interior chamber ignites a compressed fuel/air mixture therein to create a firing stroke moving the rotary piston wall in the opposite direction, so that each of the four spark plugs fires in sequence as the two portions of each of the two vertical chambers cycle through the four cycles;
a series of spaced passageways inside the outer cylindrical casing wall, the dividing wall, the rotary piston wall and the rotary piston wall post to receive oil pumped under pressure through the spaced passageways and through an external oil cooler to cool the engine block and to lubricate the rotary piston wall;
wherein the rotary piston wall and the two rotatable valve cylinders are the only moving parts in the engine block so that the engine block system operates in a highly efficient manner for fuel efficiency, low exhaust emissions, low maintenance, and long life.

2. The system of claim 1 further comprising a sleeve lining within the cylindrical engine casing, the sleeve lining being removable and replaceable.

3. The system of claim 1 further comprising a rectangular stock for sealing a portion of the inner chamber during combustion in a firing cycle, the rectangular stock being forced and held in place by the use of engine oil pressure.

4. The system of claim 1 wherein the engine block has few parts for ease of assembly and disassembly.

5. The system of claim 1 wherein application of the engine block system can vary based upon the diameter and the length of the engine casing.

6. The system of claim 5 wherein a small diameter engine casing produces a high RPM and low torque for applications to vehicles for fast speed.

7. The system of claim 5 wherein a large diameter engine casing produces a low RPM and high torque for applications to vehicles for hauling loads.

8. The system of claim 5 wherein using various engine casing diameters and engine casing lengths enables a variety of applications including use in automobiles, trucks, lawnmowers, weed-eaters, blowers, high performance race cars, tractor-trailers, boats, and aircraft.

9. The system of claim 1 where engine block system output in horsepower to weight ratio is extremely high.
